(19) United States
(12) Patent Application Publication
(10) Pub. No.: US 2024/0084553 A1
(43) Pub. Date: Mar. 14, 2024

(54) SYSTEM AND METHOD FOR COMMUNICATING MACHINE IMPACTS TO REMOTE OPERATOR WORKSTATION

(71) Applicant: Caterpillar Inc., Peoria, IL (US)

(72) Inventors: Micheal David Valerio, Morton, IL (US); Keith Robert Kosowski, Holly Springs, NC (US); Richard Ryan Evenson, Apex, NC (US); Brad R. Van De Veer, Washington, IL (US)

(73) Assignee: Caterpillar Inc., Peoria, IL (US)

(21) Appl. No.: 17/931,985

(22) Filed: Sep. 14, 2022

(51) Int. Cl. E02F 9/20; E02F 9/26; G06F 3/01

(52) U.S. Cl. CPC E02F 9/205; E02F 9/26; G06F 3/016; G06F 2203/014

(57) ABSTRACT

A system for communicating an impact sustained by a work machine moving at a worksite to a remote operator workstation for controlling the work machine through the remote operator workstation. The system includes a controller configured to obtain data associated with an acceleration of the work machine along one or more degrees of motion during a movement of the work machine at the worksite and derive an acceleration value based on the data. The controller is further configured to issue a notification of the impact of the work machine to the remote operator workstation through an output device of the remote operator workstation if the acceleration value exceeds a threshold acceleration value during the movement of the work machine.

### TECHNICAL FIELD

The present disclosure relates to communicating an impact sustained by a work machine (e.g., an impact sustained because of the work machine's movement over an uneven ground surface) to a remote operator workstation for controlling the work machine through the remote operator workstation.

### BACKGROUND

Work machines, such as track-type tractors, are often required to perform a variety of operations, ranging from pushing loose material or debris to grading, production dozing, and scraping. Many a time, these operations are required to be performed in challenging conditions of a worksite, such as, along a steep incline or a slope or over and across an uneven terrain of the worksite. As an example, when operating (e.g., moving or transitioning) such work machines over an uneven terrain, the work machine may repeatedly sustain jerks and/or impacts owing to the unevenness of the terrain. The work machine may also sustain impacts from other objects or obstacles (e.g., a wall or a side curb) present at the worksite.

An operator physically stationed within an operator cabin of the work machine may readily perceive and feel the severity of an impact and can accordingly adjust their operating style. However, an operator stationed and operating the work machine remotely may suffer from inadequate machine feedback and/or a dulled perception of the severity of the impact, resulting in either a delayed response or a no response to take corrective actions. If the severity of collision is not properly perceived by the operator, impacts to the work machine may go unaddressed, potentially resulting in premature wear and reduced life of the components of the work machine. If the impacts were severe enough, they can damage the work machine warranting repair or replacement of one or more of the work machine's components, leading to machine downtime and loss of production.

U.S. Pat. No. 8,833,861 relates to machines configured to carry payloads of heavy aggregate materials such as those used, for example, in surface mining operations. A machine including a frame and a dump body is described. An electronic controller is operably connected to the machine. At least one accelerometer is disposed to measure an acceleration of the frame and/or the dump body, and to provide an acceleration signal to the electronic controller. The electronic controller is disposed to receive and analyze the acceleration signal and provide a loading signal indicative of a severe loading condition to a remote control station and/or a loading machine performing the loading.

### SUMMARY

In one aspect of the present disclosure, a system for communicating an impact sustained by a work machine moving at a worksite to a remote operator workstation for controlling the work machine through the remote operator workstation is described. The system includes a controller configured to obtain data associated with an acceleration of the work machine along one or more degrees of motion during a movement of the work machine at the worksite and derive an acceleration value based on the data. The controller is further configured to issue a notification of the impact of the work machine to the remote operator workstation through an output device of the remote operator workstation if the acceleration value exceeds a threshold acceleration value during the movement of the work machine.

In another aspect of the present disclosure, a method for communicating an impact sustained by a work machine moving at a worksite to a remote operator workstation for controlling the work machine through the remote operator workstation is disclosed. The method includes obtaining, by a controller, data associated with an acceleration of the work machine along one or more degrees of motion during a movement of the work machine at the worksite and deriving, by the controller, an acceleration value based on the data. The method further includes issuing, by the controller, a notification of the impact of the work machine to the remote operator workstation through an output device of the remote operator workstation if the acceleration value exceeds a threshold acceleration value during the movement of the work machine.

In yet another aspect of the present disclosure, a work machine system is described. The work machine system includes a work machine, a remote operator workstation for controlling the work machine at a worksite, and a system for communicating an impact sustained by the work machine moving at the worksite to the remote operator workstation for controlling the work machine through the remote operator workstation. The system includes a controller configured to obtain data associated with an acceleration of the work machine along one or more degrees of motion during a movement of the work machine at the worksite and derive an acceleration value based on the data. The controller is further configured to issue a notification of the impact of the work machine to the remote operator workstation through an output device of the remote operator workstation if the acceleration value exceeds a threshold acceleration value during the movement of the work machine.

### BRIEF DESCRIPTION OF THE DRAWINGS

FIG. 1 is a view of an exemplary work machine moving at a worksite, in accordance with an embodiment of the present disclosure;

FIG. 2 is a schematic of a work machine system for communicating an impact sustained by the work machine to a remote operator workstation, in accordance with an embodiment of the present disclosure;

FIGS. 3 through 5 are various views of visual indicators displayed on a remote operator display interface of the remote operator workstation, in accordance with an embodiment of the present disclosure; and

FIG. 6 is a flowchart illustrating steps of a method for communicating the impact sustained by the work machine to the remote operator workstation, in accordance with an embodiment of the present disclosure.

### DETAILED DESCRIPTION

Reference will now be made in detail to specific embodiments or features, examples of which are illustrated in the accompanying drawings. Wherever possible, the same reference numbers will be used throughout the drawings to refer to the same or the like parts.

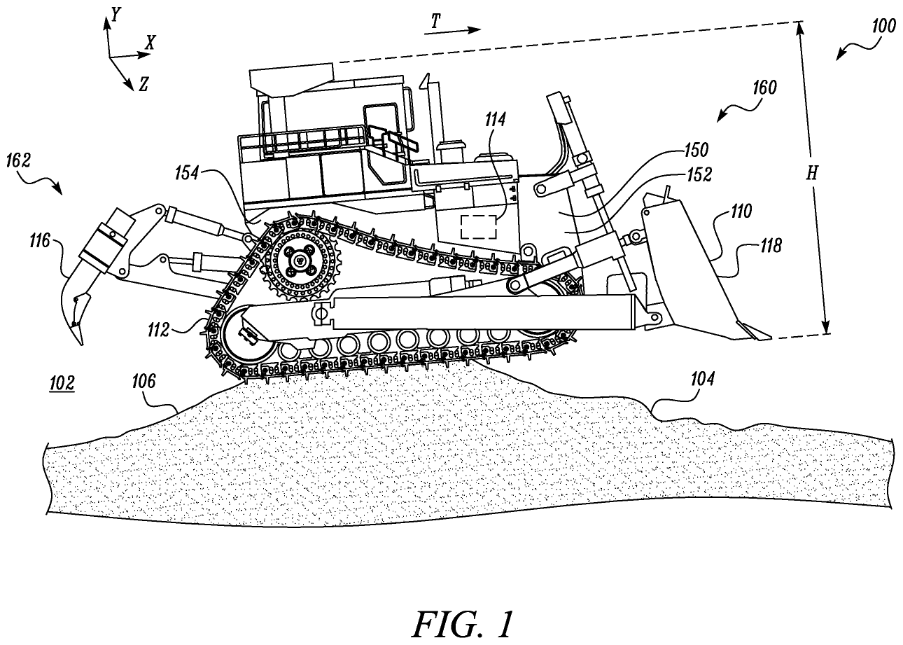

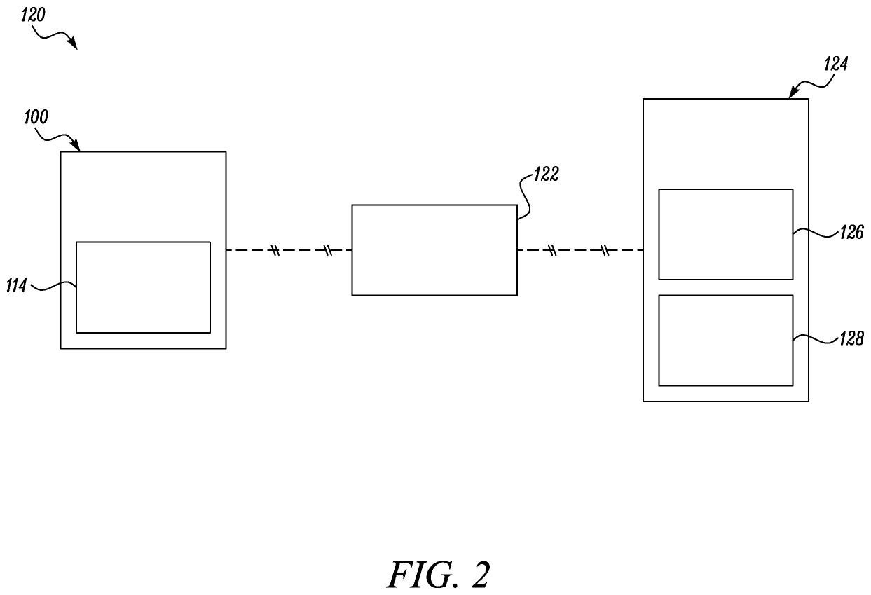

Referring to FIG. 1, an exemplary work machine 100 operating at a worksite 102 is illustrated. The worksite 102 may include a mine site, a landfill, a quarry, a construction site, or any other type of worksite having one or more surface irregularities 104. The surface irregularities 104 may include waves, undulations, uneven surfaces, steep inclines, slopes, objects, or obstacles present on a ground surface 106 of the worksite 102. The surface irregularities 104 may also embody features, such as a wall or a side curb, present at the worksite 102. As exemplarily depicted, the work machine 100 is embodied as a construction machine and may include a track-type tractor. The track-type tractor may be employed to operate at the worksite 102, for example, for moving along a steep incline or a slope or over and across an uneven surface, including slope transitions, of the worksite 102. Although the reference to a track-type tractor, the work machine 100 may include other mobile machines that performs operations, such as mining, construction, farming, etc., at a worksite similar to the worksite 102. For example, the work machine 100 may include, but is not limited to, a wheel loader, a truck, a crane, an earth moving machine, a mining machine, a backhoe, material handling equipment, farming equipment, an excavator, a dozer, a loader, a motor grader, a dump truck, and other types of machines employed to perform operations at various worksites. The work machine 100 may be an unmanned machine having various levels of autonomy, such as a semi-autonomous machine or a remotely operated machine, that receives commands related to its motion and function from a remote operator workstation 124 (shown in FIG. 2).

The work machine 100 includes a frame 150 having a forward frame portion 152 and a rearward frame portion 154. The forward frame portion 152 may define a forward end 160 of the work machine 100, while the rearward frame portion 154 may define a rearward end 162 of the work machine 100. The terms ‘forward’ and ‘rearward’, as used herein, are in relation to an exemplary direction of travel of the work machine 100, as represented by arrow, T, in FIG. 1, with said direction of travel being exemplarily defined from the rearward end 162 towards the forward end 160. Such an exemplary direction of travel, as noted, may be reversed by the work machine 100, as and when required.

The work machine 100 may be equipped with one or more implements 110, such as a ripper 116 and a blade 118, pivotably and/or operably connected to the frame 150. The implements 110 are capable of performing various operations, such as ripping, grading, and/or moving material at the worksite 102. Although the implements 110 are shown as a ripper 116 and a blade 118, any type of implements (e.g., buckets, forks, etc.), or no implement at all, may be applied by the work machine 100. The work machine 100 may also include a travel mechanism 112 supported by the frame 150, that engages the ground surface 106 to move the work machine 100 in the direction of travel, T. The travel mechanism 112 may include traction devices, such as crawler tracks, wheels, or a combination of the two. In the exemplary embodiment shown in FIG. 1, the travel mechanism 112 includes crawler tracks.

The work machine 100 may further include an inertial measurement unit (IMU) sensor 114 to provide data associated with an acceleration of the work machine 100. The IMU sensor 114 may provide signals indicative of the data associated with the acceleration of the work machine 100 along one or more degrees of motion (for example, along X axis, Y axis, and Z axis) of the work machine 100. In this regard, the IMU sensor 114 may include a 3-degree of freedom accelerometer. In accordance with one or more exemplary embodiments, the X axis is aligned with the direction of travel ‘T’ when the work machine 100 moves forward. The Y axis extends horizontally perpendicular to the X axis and is aligned with the height ‘H’ of the work machine 100. The Z axis extends transversally to the work machine 100 or along a width of the work machine 100.

For example, the IMU sensor 114 may detect an acceleration (or a change in the acceleration) in the Y direction when the work machine 100 traverses over the surface irregularities 104 such as, waves, undulations, or slope transitions, etc. Similarly, the IMU sensor 114 may detect an acceleration (or a change in the acceleration) in Z direction and X direction when the work machine 100 correspondingly takes a frontal impact or a side impact against features such as the side curb or a wall of the worksite 102.

Referring to FIG. 2, a work machine system 120 is described. The work machine system 120 includes the work machine 100, a controller 122, and the remote operator workstation 124. The controller 122 is communicably coupled to the work machine 100 and the remote operator workstation 124 to communicate wirelessly, for example, by use of radio or other electromagnetic digital or analog transmission or conventional wired and/or wireless mechanisms. In some embodiments, the controller 122 may be positioned within the work machine 100. In some alternate embodiments, the controller 122 may be positioned outside the work machine 100, such as, within the remote operator workstation 124.

The controller 122 may be configured for communicating an impact sustained by the work machine 100 moving at the worksite 102 to the remote operator workstation 124 (e.g., through an output device 126 of the remote operator workstation 124) (discussed later) for controlling the work machine 100 through the remote operator workstation 124. The controller 122 is configured to communicate with the IMU sensor 114 of the work machine 100 to obtain the data associated with the acceleration (that may include a change in the acceleration) of the work machine 100 along the one or more degrees of motion during the movement of the work machine 100 at the worksite 102. For example, the controller 122 may be configured to obtain the data associated with the acceleration of the work machine 100 in the X, Y, and Z directions.

The controller 122 is further configured to derive an acceleration value (av) based on the obtained data. As an example, the controller 122 may be configured to detect three components x, y, z, of the acceleration (or a change in the acceleration) of the work machine 100 correspondingly along three degrees of motion from the data received from the IMU sensor 114; determine a square of each component of the three components of the acceleration to attain three corresponding square values represented as, x², y², z²; summate the three corresponding square values with each other to deduce a summated value represented as x²+y²+z²; and compute a square root of the summated value to arrive at the acceleration value (av) represented as below:

av=\sqrt{x²+y²+z²}

The controller 122 is also configured to compare the acceleration value (av) with a threshold acceleration value to determine the impact. The controller 122 is configured to issue a notification of the impact of the work machine 100 to a remote operator workstation 124, for example, through an output device 126 of the remote operator workstation 124, if the acceleration value exceeds the threshold acceleration value during the movement of the work machine 100.

The threshold acceleration value may be determined based on the On Machine Stress Analysis (OMSA) of the work machine 100. The OMSA can refer to a machine test performed to evaluate the structural durability of the work machine 100 and the results of the OMSA may differ for different work machines 100. For example, the OMSA results for a track-type tractor may be different from the OMSA results of a wheel loader. In accordance with various embodiments of the present disclosure, the threshold acceleration value for each work machine 100 may differ based on the OMSA results of that work machine 100. In accordance with various embodiments of the present disclosure, the controller 122 is further configured to deactivate the notification after lapse of a predefined period from an issuance of the notification.

In some embodiments, there may be more than one threshold acceleration value, e.g., a first threshold acceleration value and a second threshold acceleration value, and the controller 122 may be configured to change one or more attributes of the notification based on a severity of the impact. In other words, when the acceleration value exceeds the first threshold acceleration value, the controller 122 may issue the notification with a first attribute and when the acceleration value exceeds the second threshold acceleration value, the controller 122 may issue the notification with a second attribute. The first attribute may be different from the second attribute. Also, the second threshold acceleration value may be different from the first threshold acceleration value and may be greater or higher than the first threshold acceleration value.

In accordance with various embodiments, the controller 122 is configured to issue another notification (e.g., a second notification) similar to the notification (which may be a first notification) described above, whenever another impact is sustained by the work machine 100 in pursuance to an initial impact. In some embodiments, the controller 122 is configured to issue the second notification subsequently to the issuance of the first notification after a lapse of a predetermined duration from an issuance of the first notification. By doing so, the controller 122 regulates the frequency of the notifications provided to the remote operator workstation 124 as it may be expected that the remote operator would have taken certain corrective action based on the initial notification. In some embodiments, the predetermined duration may be equal to or greater than the predefined period.

The controller 122 may be regarded as being inclusive of one or more microprocessors, microcontrollers, digital signal processors (DSPs), state machines, logic circuitry, or other devices known to persons skilled in the art to process information or signals based on operational or programming instructions. The controller 122 may be implemented using one or more controller technologies, such as Application Specific Integrated Circuit (ASIC), Reduced Instruction Set Computing (RISC) technology, Complex Instruction Set Computing (CISC) technology or other similar technology known to persons skilled in the art.

The remote operator workstation 124 is operable as an interface by the remote operator for controlling the work machine 100. The remote operator may utilize one or more input devices of the remote operator workstation 124 for providing commands related to the motion and other functions of the work machine 100 to the work machine 100. For example, the input device may include one or more of steering wheels, levers, foot pedals, control joysticks, touch-screen, and/or buttons. The remote operator workstation 124 may be locally situated at the worksite 102 or may alternatively be remotely located. The remote operator workstation 124 may be configured to communicate with the work machine 100 wirelessly, for example, by use of radio or other electromagnetic digital or analog transmission.

The remote operator workstation 124 is configured to receive the notification of the impact of the work machine 100 from the controller 122. To this end, the remote operator workstation 124 may include, among other components, an output device 126 and an operator accessible apparatus 128 to notify the remote operator of the impact. The output device 126 may include one or more remote operator display interfaces (which may optionally include the aforementioned touch screen of the remote operator workstation 124), a speaker, and/or a motion inducing device. As an example, the remote operator display interfaces may include a primary remote operator display interface and a secondary remote operator display interface.

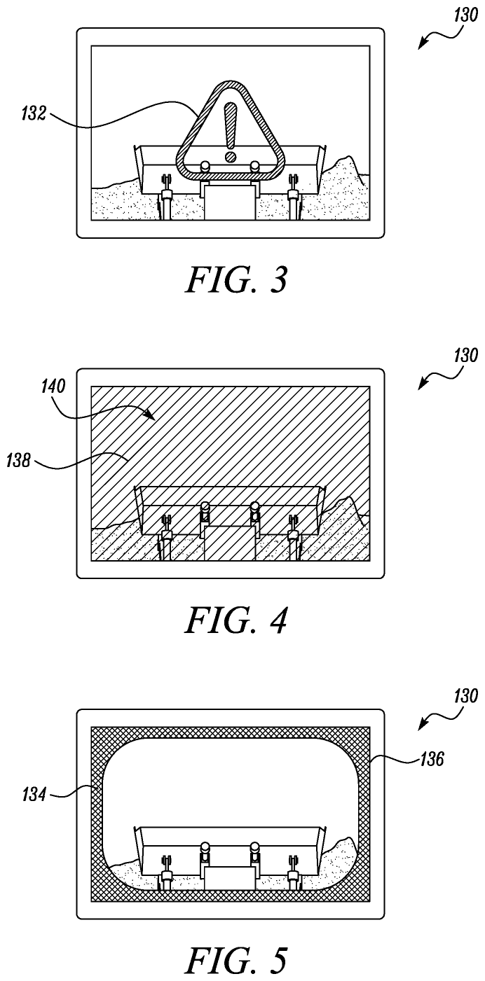

In an embodiment, with regard to the primary remote operator display interface 130 (shown in FIGS. 3 through 5) of the remote operator workstation 124, the notification may correspond to a visual indicator displayed on the primary remote operator display interface 130 of the remote operator workstation 124. The primary remote operator display interface 130 may correspond to a display interface that provides a view 140 of one or more operations performed by the work machine 100 at the worksite 102. FIGS. 3 through 5 are illustrations of various exemplary visual indicators displayed on the primary remote operator display interface 130 of the remote operator workstation 124. As shown in FIG. 3, the visual indicator may include a symbol, such as, a hazard symbol 132, displayed on the primary remote operator display interface 130. Further, as shown in FIG. 4, the visual indicator may include a colored visual overlay 138 provided on the view 140 captured on the primary remote operator display interface 130. In some embodiments, the visual indicator may include a colored borderline 134 at a periphery 136 of the primary remote operator display interface 130, as shown in FIG. 5.

With regard to the secondary remote operator display interface of the remote operator workstation 124, the notification (which may or may not be similar to the notification displayed on the first remote operator display interface 130) may correspond to a visual indicator displayed on the secondary remote operator display interface of the remote operator workstation 124. The secondary remote operator display interface may correspond to a display interface that shows in-cab display information, such as, tachometer, fuel level, machine faults, error codes, and so on. The visual indicator may include a symbol, such as, a hazard symbol, a colored visual overlay, a colored borderline, or a short written description of the impact displayed on the secondary remote operator display interface of the remote operator workstation 124.

In another embodiment, when the output device 126 corresponds to the speaker of the remote operator workstation 124, the notification corresponds to an audible indicator provided via the speaker of the remote operator workstation 124. In yet another embodiment, when the output device 126 corresponds to the motion-inducing device of the remote operator workstation 124, the notification corresponds to a haptic feedback induced by the motion inducing device into the operator accessible apparatus 128, such as, a remote operator seat, armrests, the control joysticks, or the foot pedals, of the remote operator workstation 124. For example, the haptic feedback may include one or more of vibrations or oscillations induced in the operator accessible apparatus 128 of the remote operator workstation 124. In exemplary scenarios, the haptic feedback or vibrations, issued as part of a notification, may be induced into the remote operator seat when an operator is seated on or over the remote operator seat.

The attributes of the notification may include one or more of a pattern, a color, or an opaqueness of the visual indicator, volume level, tone, or pattern of the audible indicator, and/or intensity of the haptic feedback. In an embodiment, the pattern, such as, flashing, fading, or pulsing of the visual indicator may be changed based on the severity of the impact. For example, the flashing, fading, or pulsing of the visual indicator may be increased in response to a high severity of the impact (with the acceleration value exceeding the second threshold acceleration value exemplarily meaning or corresponding to the high severity of the impact) and decreased in response to a low severity of the impact (with the acceleration value exceeding the first threshold acceleration value but not the second threshold acceleration value exemplarily meaning or corresponding to the low severity of the impact). Similarly, the intensity or opaqueness of the visual indicator may be increased in response to the high severity of the impact and decreased in response to the low severity of the impact. Furthermore, in some embodiments, the volume level, tone, or pattern of the audible indicator may be changed based on the impact, for example, to create a sound effect similar to the sound effect created in the operator cabin of the work machine 100 when the work machine 100 is experiencing the impact. For example, the volume level or the tone of the audible indicator may be increased in response to the high severity of the impact and decreased in response to the low severity of the impact. Similarly, the intensity of the haptic feedback may be increased in response to the high severity of the impact and decreased in response to the low severity of the impact.

### INDUSTRIAL APPLICABILITY

During operation, when the work machine 100 traverses the worksite 102, the work machine 100 may repeatedly sustain jerks and/or impacts owing to the surface irregularities 104 at the worksite 102. For an operator physically stationed within an operator cabin of the work machine 100, it is feasible to perceive and feel the severity of an impact and can adjust the operating style accordingly. However, the remote operator stationed and operating the work machine remotely via the remote operator workstation 124 may not perceive and feel the impact sustained by the work machine 100. In accordance with various embodiments of the present disclosure, the impacts sustained by the work machine 100 due to the surface irregularities 104 may be determined based on the data obtained from the IMU sensor 114 and notified to the remote operator workstation 124 to take corrective actions.

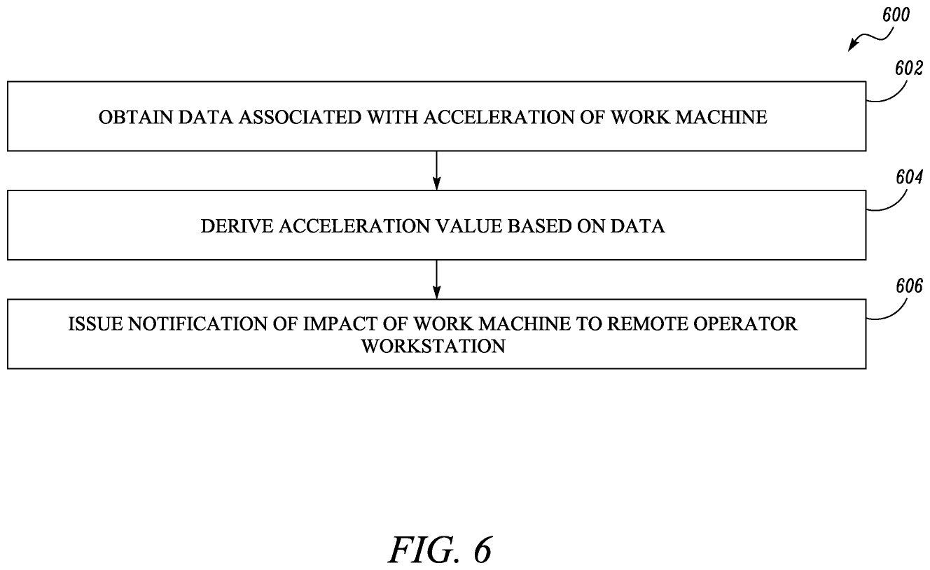

FIG. 6 shows a method 600 for communicating the impact sustained by the work machine 100 moving at the worksite 102 to the remote operator workstation 124. At step 602, the controller 122 obtains the data associated with the acceleration of the work machine 100 along the one or more degrees of motion during the movement of the work machine 100 at the worksite 102. At step 604, the controller 122 derives the acceleration value based on the obtained data. The controller 122 further issues a notification of the impact of the work machine 100 to the remote operator workstation 124 through the output device 126 of the remote operator workstation 124 if the acceleration value exceeds the threshold acceleration value during the movement of the work machine 100, at step 606.

The present disclosure provides a method and system to notify the remote operator of the work machine 100 of the impact sustained by the work machine 100 on the worksite 102 due to the one or more surface irregularities 104 present at the worksite 102. The notifications enable the remote operator to effectively operate the work machine 100 and avoid any potential wear or damage to the work machine 100 by providing feedback and perception of the severity of the impact at the worksite 102 or a collision of the work machine 100 against any feature or structure present at the worksite 102. This increases the life of the components of the work machine 100 and reduces the need for the repair or replacement of one or more of the work machine's component, saving time, effort, and cost.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for communicating an impact sustained by a work machine moving at a worksite to a remote operator workstation for controlling the work machine through the remote operator workstation, the system comprising:
a controller configured to:
obtain data associated with an acceleration of the work machine along one or more degrees of motion during a movement of the work machine at the worksite;
derive an acceleration value based on the data; and
issue a notification of the impact of the work machine to the remote operator workstation through an output device of the remote operator workstation if the acceleration value exceeds a threshold acceleration value during the movement of the work machine.

2. The system of claim 1, wherein the output device corresponds to at least one remote operator display interface of the remote operator workstation and the notification corresponds to a visual indicator displayed on the at least one remote operator display interface.

3. The system of claim 2, wherein the visual indicator includes one or more of a symbol, a colored borderline at a periphery of the at least one remote operator display interface, a written description, and/or a colored visual overlay provided on a view captured on the at least one remote operator display interface of the remote operator workstation.

4. The system of claim 1, wherein the output device corresponds to a speaker of the remote operator workstation and the notification corresponds to an audible indicator provided via the speaker.

5. The system of claim 1, wherein the output device corresponds to a motion inducing device of the remote operator workstation and the notification corresponds to a haptic feedback including one or more of vibrations or oscillations induced by the motion inducing device into an operator accessible apparatus of the remote operator workstation, wherein the operator accessible apparatus includes one or more of a remote operator seat, armrests, joystick controls, and foot pedals of the remote operator workstation.

6. The system of claim 1, wherein to derive the acceleration value, the controller is configured to:
detect three components of the acceleration of the work machine correspondingly along three degrees of motion;
determine a square of each component of the three components of the acceleration to attain three corresponding square values;
summate the three corresponding square values with each other to deduce a summated value; and
compute a square root of the summated value to arrive at the acceleration value.

7. The system of claim 1, wherein the data associated with the acceleration of the work machine is obtained from an inertial measurement unit sensor of the work machine.

8. The system of claim 1, wherein the controller is configured to deactivate the notification after lapse of a predefined period from an issuance of the notification.

9. The system of claim 1, wherein the notification is a first notification, the controller is configured to issue a second notification subsequently to the issuance of the first notification after the lapse of a predetermined duration from an issuance of the first notification, wherein the second notification is similar to the first notification.

10. A method for communicating an impact sustained by a work machine moving at a worksite to a remote operator workstation for controlling the work machine through the remote operator workstation, the method comprising:
obtaining, by a controller, data associated with an acceleration of the work machine along one or more degrees of motion during a movement of the work machine at the worksite;
deriving, by the controller, an acceleration value based on the data; and
issuing, by the controller, a notification of the impact of the work machine to the remote operator workstation through an output device of the remote operator workstation if the acceleration value exceeds a threshold acceleration value during the movement of the work machine.

11. The method of claim 10, wherein the output device corresponds to at least one remote operator display interface of the remote operator workstation and the notification corresponds to a visual indicator displayed on the at least one remote operator display interface.

12. The method of claim 11, wherein the visual indicator includes one or more of a symbol, a colored borderline at a periphery of the at least one remote operator display interface, a written description, and/or a colored visual overlay provided on a view captured on the at least one remote operator display interface of the remote operator workstation.

13. The method of claim 10, wherein the output device corresponds to a speaker of the remote operator workstation and the notification corresponds to an audible indicator provided via the speaker.

14. The method of claim 10, wherein the output device corresponds to a motion inducing device of the remote operator workstation and the notification corresponds to a haptic feedback including one or more of vibrations or oscillations induced by the motion inducing device into an operator accessible apparatus of the remote operator workstation, wherein the operator accessible apparatus includes one or more of a remote operator seat, armrests, joystick controls, and foot pedals of the remote operator workstation.

15. The method of claim 10, wherein deriving the acceleration value includes:
detecting three components of the acceleration of the work machine correspondingly along three degrees of motion;
determining a square of each component of the three components of the acceleration to attain three corresponding square values;
summating the three corresponding square values with each other to deduce a summated value; and
computing a square root of the summated value to arrive at the acceleration value.

16. The method of claim 10, wherein the data associated with the acceleration of the work machine is obtained from an inertial measurement unit sensor of the work machine.

17. The method of claim 10, further includes: deactivating the notification after lapse of a predefined period from an issuance of the notification.

18. The method of claim 10, wherein the notification is a first notification and wherein the method includes issuing a second notification subsequently to the issuance of the first notification after the lapse of a predetermined duration from an issuance of the first notification, wherein the second notification is similar to the first notification.

19. A work machine system, comprising:
a work machine;
a remote operator workstation for controlling the work machine at a worksite;
a system for communicating an impact sustained by the work machine moving at the worksite to the remote operator workstation for controlling the work machine through the remote operator workstation, the system including:
a controller configured to:
obtain data associated with an acceleration of the work machine along one or more degrees of motion during a movement of the work machine at the worksite;
derive an acceleration value based on the data; and
issue a notification of the impact of the work machine to the remote operator workstation through an output device of the remote operator workstation if the acceleration value exceeds a threshold acceleration value during the movement of the work machine.

20. The work machine system of claim 19, wherein the output device corresponds to one or more of at least one remote operator display interface, a speaker, and/or a motion inducing device of the remote operator workstation and the notification corresponds to one or more of a visual indicator displayed on the at least one remote operator display interface, an audible indicator provided via the speaker, and/or a haptic feedback induced by the motion inducing device into an operator accessible apparatus of the remote operator workstation.
